(19) United States
(12) Patent Application Publication
(10) Pub. No.: US 2008/0002236 A1
(43) Pub. Date: Jan. 3, 2008

(54) IMAGE FORMING APPARATUS

(75) Inventor: Michio INABA, Nagoya-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 11/739,758

(22) Filed: Apr. 25, 2007

(30) Foreign Application Priority Data
Jun. 29, 2006 (JP) 2006-179800

(51) Int. Cl. H04N 1/40

(52) U.S. Cl. 358/471

(57) ABSTRACT

An image forming apparatus can include an integrated memory portion capable of storing settings information, a memory connection portion communicably connected to an external memory that stores settings update information, a detection portion capable of detecting a connection state and a disconnection state of the external memory with respect to the memory connection portion, a settings updating portion capable of rewriting settings information that is stored in the integrated memory portion based on settings update information that is stored in the external memory, and a control portion capable of executing restarting of the image forming apparatus after the settings updating portion executes rewriting of the settings information, based on a signal from the detection portion that the external memory is in the disconnected state.

### CROSS REFERENCE TO RELATED APPLICATION

This application claims priority from Japanese Patent Application No. 2006-179800 filed Jun. 29, 2006. The entire contents of this priority application is incorporated herein by reference.

### TECHNICAL FIELD

This disclosure relates to an image forming apparatus, and more particularly to an image forming apparatus in which settings can be updated using an external memory.

### BACKGROUND

For image forming apparatuses such as facsimile apparatuses, technology has already been proposed that rewrites settings information in accordance with a settings file that is recorded in an external memory, when mounting the external memory on the apparatus or when turning on the power. It is thereby possible to enhance operability when changing settings such as operating conditions and the like for a large number of image forming apparatuses.

For example, a given facsimile apparatus may be configured such that, when an external memory is mounted on the apparatus by a user, the apparatus first checks whether or not there is a settings update file in that external memory. And when a settings update file exists, the apparatus rewrites the settings in accordance with the contents of that file, and thereafter restarts the apparatus to complete the settings update.

According to the image forming apparatus as described above, it is necessary for the user to remove the external memory from the apparatus when restarting the apparatus. More specifically, if the user forgets to remove the external memory, the problem arises that after the apparatus rewrites the settings information and restarts, the apparatus repeats the same operations again in which it checks whether or not a settings update file is recorded in the external memory, and again rewrites the setting information in accordance with the contents of the settings update file and restarts.

In view of the above described circumstances, technology is required that prevents the occurrence this problem when updating settings using an external memory.

### SUMMARY

An image forming apparatus can include an integrated memory portion capable of storing settings information, a memory connection portion communicably connected to an external memory that stores settings update information, a detection portion capable of detecting a connection state and a disconnection state of the external memory with respect to the memory connection portion, a settings updating portion capable of rewriting settings information that is stored in the integrated memory portion based on settings update information that is stored in the external memory, and a control portion capable of executing restarting of the image forming apparatus after the settings updating portion executes rewriting of the settings information, based on a signal from the detection portion that the external memory is in the disconnected state.

### BRIEF DESCRIPTION OF THE DRAWINGS

Illustrative aspects in accordance with the invention will be described in detail with reference to the following figures wherein:

FIG. 1 is a block diagram that illustrates the electrical configuration of a USB memory and a printer according to one illustrative aspect of the present invention;

FIG. 2 is a flowchart that illustrates the flow of startup processing;

FIG. 3 is a flowchart that illustrates the flow of print processing;

FIG. 4 is a flowchart that illustrates the flow of reprint processing;

FIG. 5 is a flowchart that illustrates the flow of automatic setting processing;

FIG. 6 is a flowchart that illustrates the flow of automatic setting processing according to another illustrative aspect; and

FIG. 7 is a flowchart that illustrates the flow of automatic setting processing according to a further illustrative aspect of the present invention.

### DETAILED DESCRIPTION

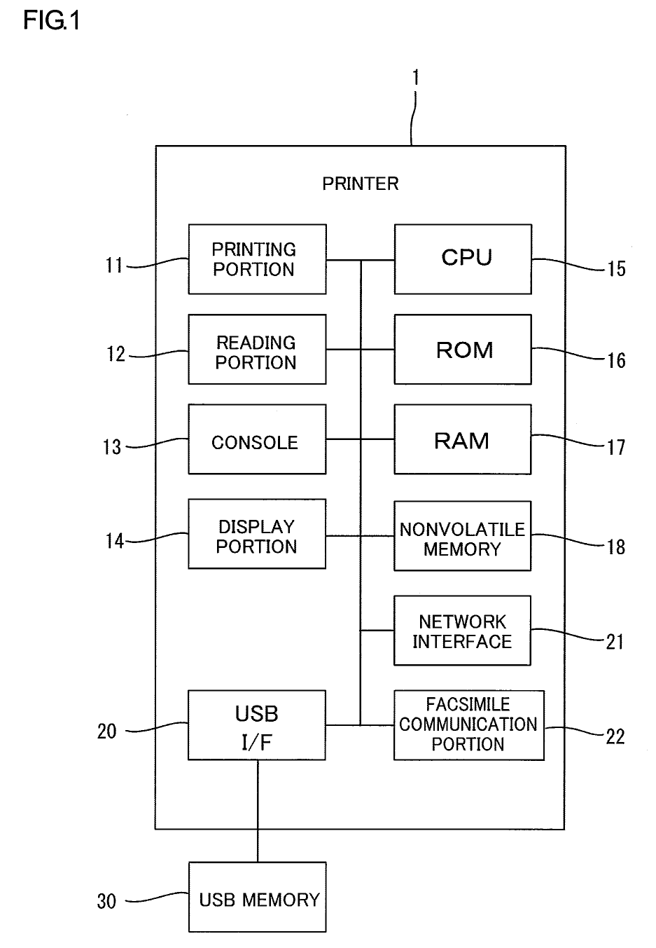

Various illustrative aspects of the present invention will be described with reference to FIG. 1 to FIG. 5.

### 1. Overall Configuration of Printer

FIG. 1 is a block diagram that schematically shows the electrical configuration of a printer 1 (one example of “image forming apparatus”) according to one or more aspects of the present invention. The printer 1 can include a printing portion 11, a reading portion 12, a console 13 (one example of “restart console” and “input portion”), a display portion 14, a CPU 15 (one example of “control portion”, “settings updating portion”, and “allocating portion”), a ROM 16, a RAM 17 (one example of “storage portion”), a nonvolatile memory 18 (one example of “integrated memory portion”), a USB interface 20 (one example of “memory connection portion” and “detection portion”), a network interface 21, and a facsimile communication portion 22.

The printing portion 11 prints an image that is based on image data on a sheet as a print medium. The reading portion 12 reads an original image. The console 13 may include a power button and a plurality of keys, and accepts various kinds of input operations by a user. The display portion 14 may include a liquid crystal panel or the like, and performs various kinds of displays.

Various control programs for controlling the printer 1, various settings and initial values and the like can be stored in the ROM 16. The RAM 17 is used as a work area to which various control programs are read out.

In accordance with control programs that are read out from the ROM 16, the CPU 15 controls the operations of the printing portion 11 and display portion 14 while storing the processing results in the RAM 17 or the nonvolatile memory 18. The nonvolatile memory 18 stores, for example, various kinds of settings information such as setting values for a reprint execution flag or the contents of an address book.

A USB memory 30 (one example of “external memory”) is detachably connected to the USB interface 20, and information inside the USB memory 30 can be read into the printer 1 side through the USB interface 20. The USB interface 20 also detects the state of mounting/removal of the USB memory 30, and outputs the detection signal to the CPU 15. One skilled in the art will appreciate that the memory and the interface of one or more aspects of the present invention, other than a USB type, can be utilized without departing from the present invention. For example, a memory and an interface could interact or communicate via a wireless system.

An external information processing device (personal computer or the like) can be connected to the network interface 21, and sending and receiving of data is possible between the external information processing device and the network interface 21. A telephone line can be connected to the facsimile communication portion 22, and sending and receiving of facsimile data is possible between the facsimile communication portion 22 and an external facsimile apparatus and the like.

### 2. Processing by Control of CPU

### (Startup Processing)

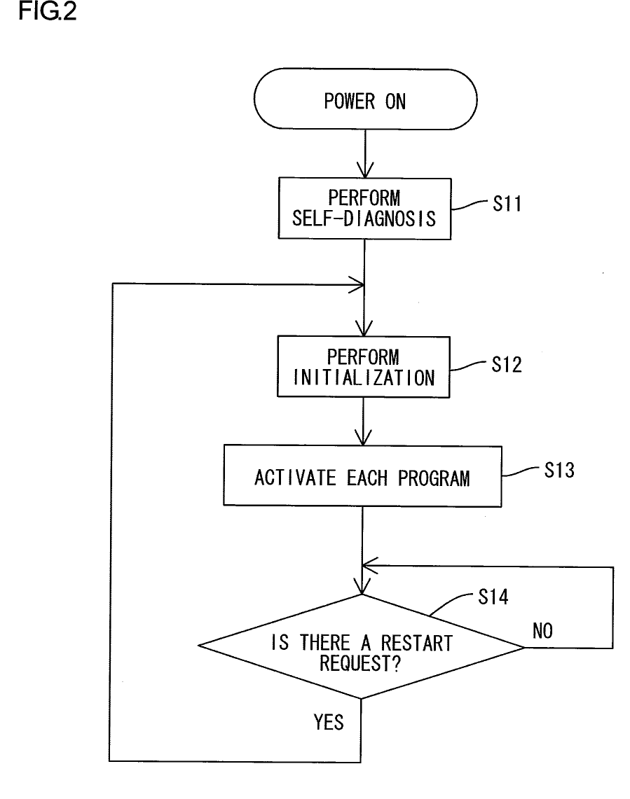

When the power is turned on, the CPU 15 executes startup processing as shown in FIG. 2. In this startup processing, first the CPU 15 can perform self-diagnosis that checks whether there is an abnormality in any portion of the printer 1 (S11), and then performs initialization (S12). In this initialization, the CPU 15 performs processing to initialize a memory area on the RAM 17 and allocate memory area. At this time, the CPU 15 refers to settings information that is stored in the nonvolatile memory 18, and if the reprint execution flag is “on” the CPU 15 secures a reprint memory area in the RAM 17 to store image data for reprinting. If the reprint execution flag is “off”, the CPU 15 does not secure a reprint memory area.

Next, the CPU 15 starts up respective programs for executing print processing, reprint processing, automatic setting processing and the like, which is described later (S13). The respective programs for executing print processing, reprint processing and automatic setting processing can be executed in parallel.

Subsequently, the CPU 15 determines whether or not a restart request flag, as described later, is “on” (S14). If the restart request flag is “off” (S14: No), the CPU 15 stands by in that state. Thereafter, if the restart request flag changes to “on” (S14: Yes), the CPU 15 returns to S12 to perform initialization.

### (Print Processing)

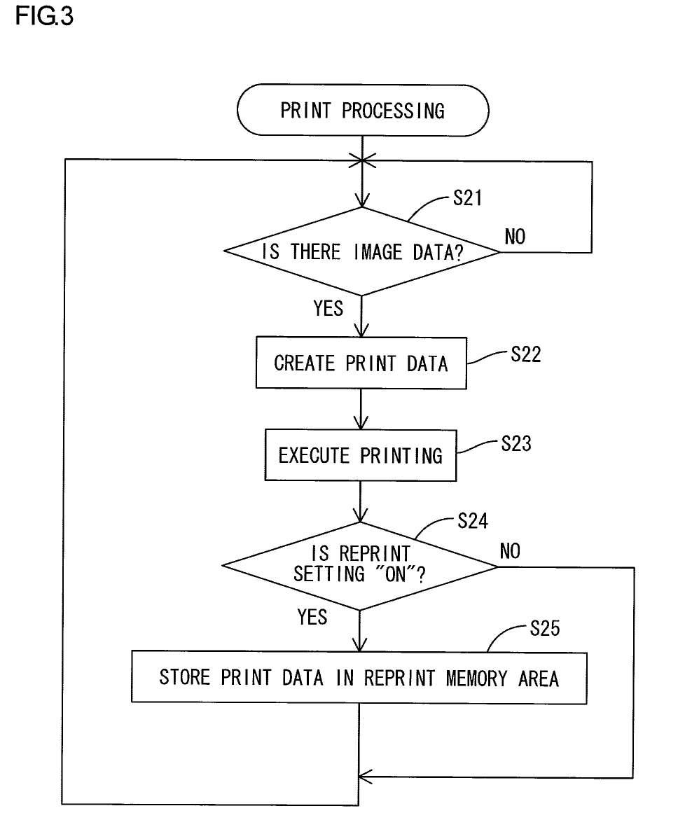

When starting print processing as shown in FIG. 3, the CPU 15 first determines whether or not there is image data to be printed on the RAM 17 (S21). In this case, the term “image data” refers to image data obtained by the reading portion 12 by reading an original image, image data read from the USB memory 30 through the USB interface 20, or image data received from outside through the network interface 21 or the facsimile communication portion 22. If there is no image data (S21: No), the CPU 15 stands by until image data to be printed is stored on the RAM 17. Those skilled in the art will appreciated that data can also be sent or obtained via a wireless system.

When image data to be printed is stored on the RAM 17 (S21: Yes), the CPU 15 analyzes that image data to create print data that is based on that image data on the RAM 17 (S22). Next, the printing portion 11 prints out an image based on that print data onto a sheet (S23).

Next, the CPU 15 determines whether or not a reprint setting that is stored on the nonvolatile memory 18 is “on” (S24). If the reprint setting is “on” (S24: Yes), the CPU 15 stores the print data for which printing has completed in the reprint memory area of the RAM 17 (S25). Thereafter, the CPU 15 returns to S21 to again standby until image data to be printed is stored on the RAM 17.

### (Reprint Processing)

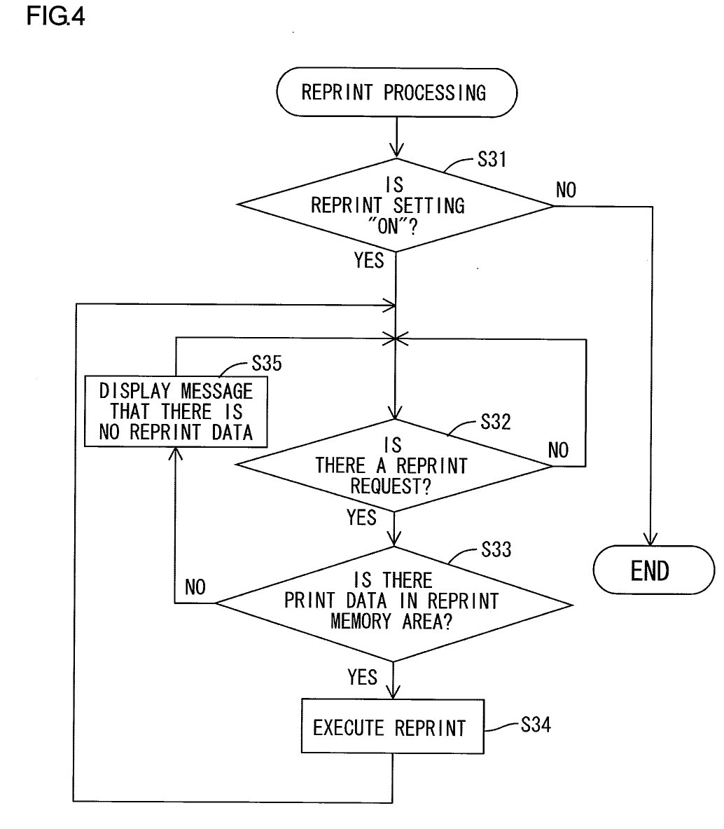

When starting reprint processing as shown in FIG. 4, the CPU 15 first determines whether or not the reprint setting stored on the nonvolatile memory 18 is “on” (S31). If the reprint setting is “off” (S31: No), the CPU 15 ends the reprint processing.

If the reprint setting is “on” (S31: Yes), the CPU 15 determines whether or not the user has performed an input operation requesting reprint from the console 13 (S32). If an input operation requesting reprint has not been performed (S32: No), the CPU 15 stands by until there is a reprint request. When an input operation requesting reprint is performed (S32: Yes), the CPU 15 checks whether or not there is print data in the reprint memory area (S33). If there is no print data, the CPU 15 displays a message to the effect that there is no print data for reprinting on the display portion 14 (S35), and then returns to S32 to repeat the same processing.

When print data exists in the reprint memory area (S33: Yes), an image that is based on that print data is printed out onto a sheet by the printing portion 11 (S34). As a result, an image that is the same as the image that was printed immediately prior thereto is printed. After executing reprinting, the CPU 15 returns to S32 to standby until input of a reprint request.

### (Automatic Setting Processing)

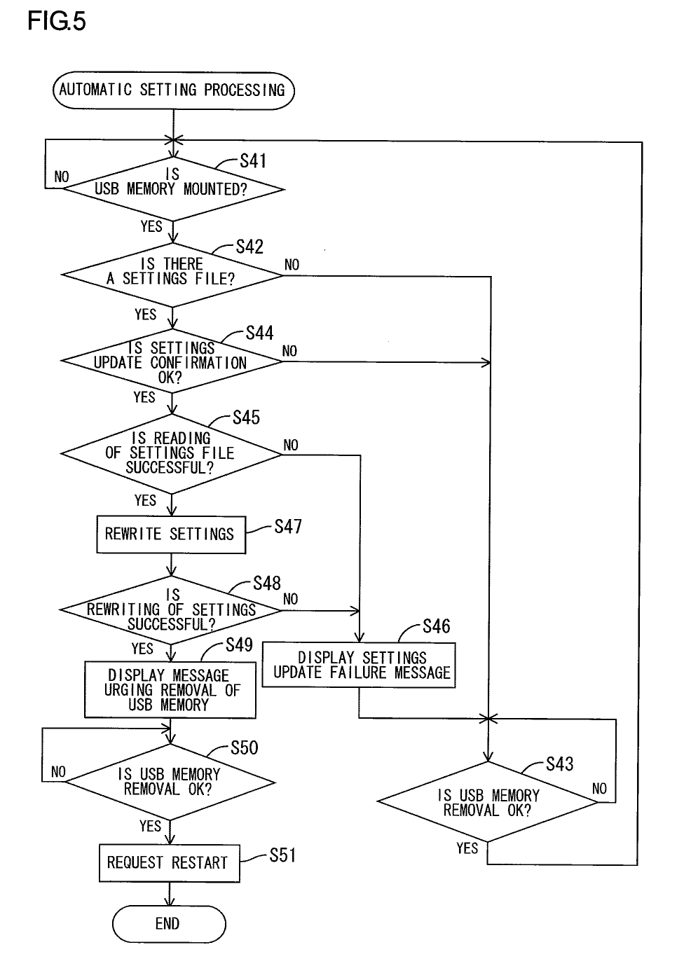

When starting the automatic setting processing as shown in FIG. 5, the CPU 15 first determines whether or not the USB memory 30 is mounted in the USB interface 20 (S41). When the USB memory 30 is not mounted (S41: No), the CPU 15 stands by for the USB memory 30 to be mounted. When the USB memory 30 is mounted (S41: Yes), the CPU 15 checks whether or not a settings file (settings update information) is stored in the USB memory 30 (S42).

If a settings file is not stored in the USB memory 30 (S42: No), the CPU 15 determines whether the USB memory 30 has been removed (S43). If the USB memory 30 has not been removed (S43: No), the CPU 15 stands by until the USB memory 30 is removed. Subsequently, when the USB memory 30 has been removed (S43: Yes), the CPU 15 returns to S41 to again stand by for the USB memory 30 to be mounted.

When a settings file is stored in the USB memory 30 (S42: Yes), the CPU 15 causes the display portion 14 to display a message to have the user confirm whether or not to execute update of the settings (S44). If the user performs an input from the console 13 to the effect that settings update is not possible (S44: No), the CPU 15 cancels execution of the settings update operation, proceeds to S43, and stands by for the mounted USB memory 30 to be removed.

In contrast, if the user performs an input from the console 13 to the effect that settings update is possible (S44: Yes), the CPU 15 reads (stores) the settings file from the USB memory 30 to the RAM 17 (S45). At this time, if reading (storing) of the settings file is not completed normally (S45: No), the CPU 15 displays a message to the effect that settings update failed on the display portion 14 (S46), and then stands by at S43 for the USB memory 30 to be removed.

In contrast, when reading (storing) of the settings file is successful (S45: Yes), the CPU 15 executes rewriting of the settings information that is stored in the nonvolatile memory 18 based on the contents of the settings file that was read onto the RAM 17 (S47). Next, the CPU 15 checks whether or not rewriting of the settings information was successful (S48). When rewriting of the settings information was not performed normally (S48: No), the CPU 15 proceeds to S46 to display a message to the effect that settings update failed on the display portion 14, and then stands by at S43 for the USB memory 30 to be removed.

When rewriting of the settings information was successful (S48: Yes), the CPU 15 causes the display portion 14 to display a remove message that urges the user to remove the USB memory 30 (S49). The CPU 15 then determines whether or not the USB memory 30 has been removed from the USB interface 20 (S50). If the USB memory 30 has not been removed (S50: No), the CPU 15 stands by for the USB memory 30 to be removed.

When the USB memory 30 has been removed (S50: Yes), the CPU 15 changes from “off” to “on” the status of the restart request flag that is stored in the RAM 17 (S51), and ends this automatic setting program. By setting the restart request flag to “on”, the printer 1 is restarted by the aforementioned startup processing (S14).

3. Effects of the Present Illustrative Aspect

According to the present illustrative aspect as described above, when updating setting using the USB memory 30, operations from rewriting of settings information to restart are performed on the condition that the USB memory 30 is removed (S50). It is thereby possible to prevent the occurrence of the problem that rewriting of settings information and a restart operation are repeated with the USB memory 30 still in a mounted state.

Further, since a decision as to whether or not to update the settings is left to the user (S44), a situation in which settings are updated against the will of the user can be prevented.

Furthermore, when processing for allocating the RAM 17 is performed based on settings information as in the present illustrative aspect, since it is necessary to restart the apparatus when a settings update was performed, the effect of one or more aspects of the present invention is advantageous over prior systems.

Furthermore, since rewriting of settings information is executed after storage of the settings file of the USB memory 30 in the RAM 17 has been completed (S45 and S47), it is possible to prevent the occurrence of a situation in which the external memory is removed during reading of a settings file from the USB memory 30 such that rewriting of the settings information cannot be performed normally.

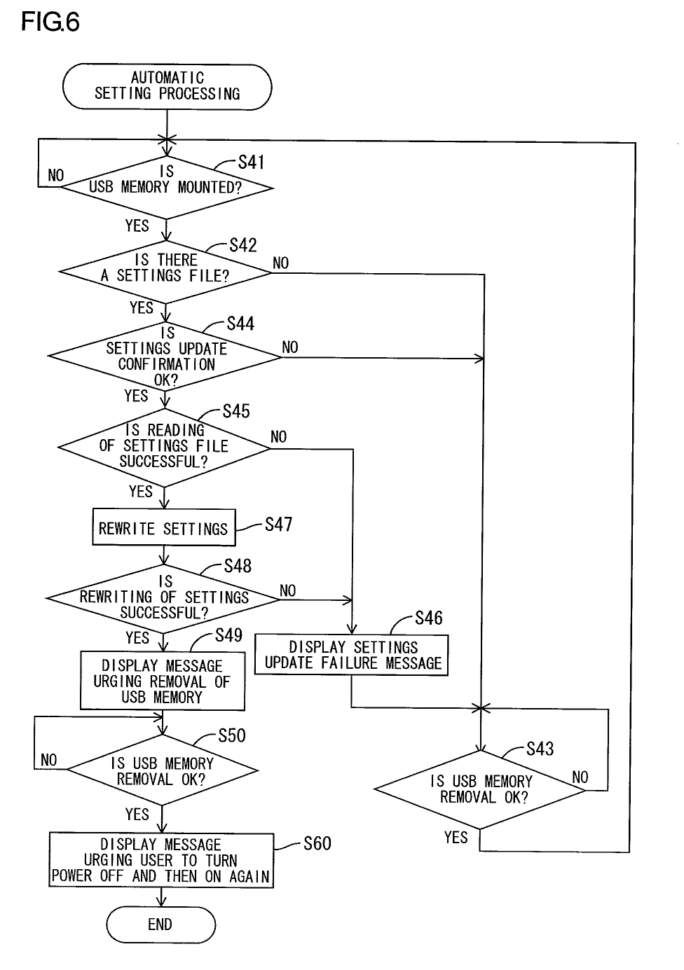

Next, another illustrative aspect of the present invention will be described with reference to FIG. 6.

According to the present illustrative aspect, instead of the restart request processing (S51) in automatic setting processing according to the illustrative aspect shown in FIG. 5, the display portion 14 displays a restart message to the effect of urging the user to perform an operation to turn on the power again (restart) (S60). In this case, when the user performs an input operation from the console 13 to instruct that the printer 1 be restarted, the restart request flag changes from “off” to “on” and the printer 1 restarts. The other processing is the same as in the illustrative aspect shown in FIG. 5. Further, the same reference numbers are used to denote processing steps in FIG. 6 that are the same as processing steps in the illustrative aspect shown in FIG. 5, and a description of those steps is omitted here.

According to the present illustrative aspect, when rewriting settings information, by displaying an instruction message that instructs the user to execute a restart operation after the USB memory 30 is removed (S49 and S60), it can be expected that restart will be executed after the USB memory 30 is removed by the user. It is thereby possible to prevent the occurrence of the problem of initiating a rewriting of settings information and a restart operation (from being repeated) with the USB memory 30 still in a mounted state.

Further, since a remove message that instructs the user to remove the USB memory 30 (S49) and a restart message that instructs the user to execute restart (S60) are displayed in order, the user can easily ascertain what operation should be performed next.

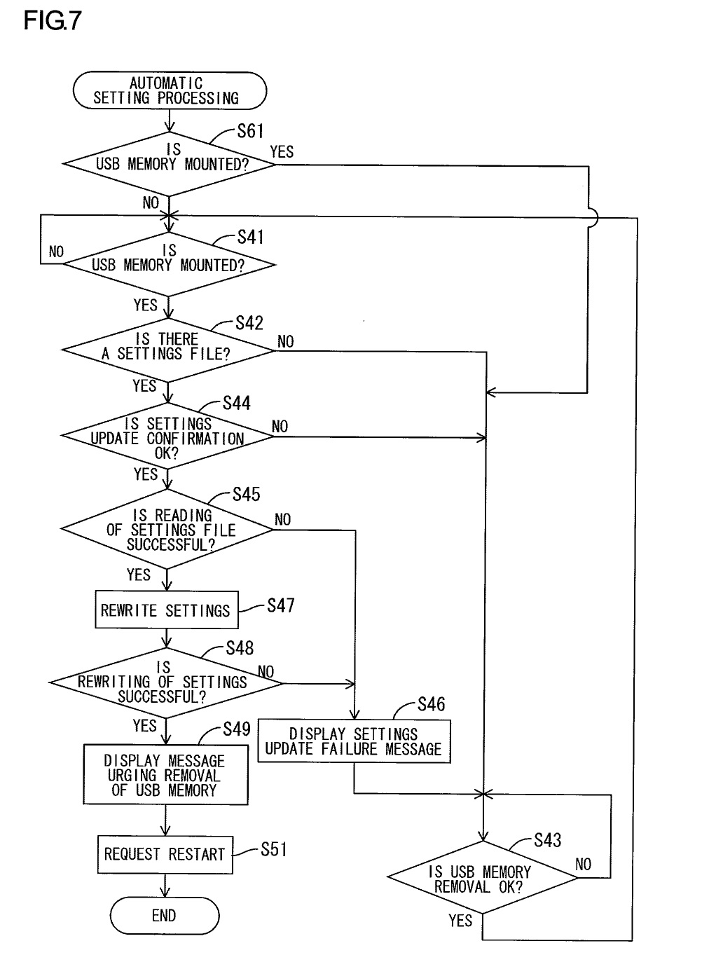

A further illustrative aspect of the present invention will now be described with reference to FIG. 7.

According to the present illustrative aspect, in the automatic setting processing the CPU 15 first performs processing to determine whether or not the USB memory 30 is mounted (S61). In this connection, since the bulk of the other processing is the same as in the illustrative aspect shown in FIG. 5, processing steps in FIG. 7 that are the same as processing steps in the illustrative aspect shown in FIG. 5 are denoted by the same reference numerals, and a description of those steps is omitted here.

The processing at S61 is executed immediately after the printer 1 is started up, that is, immediately after automatic setting processing (S13) is started when the startup processing shown in FIG. 2 is performed. In a case in which the USB memory 30 is in a mounted state at this time (S61: Yes), since there is a possibility that the USB memory 30 was not removed when performing restart after the settings were updated, the CPU 15 proceeds to S43 to stand by until the USB memory 30 is removed.

When the USB memory 30 had been removed at S61 (S61: No) or when the USB memory 30 that was in a mounted state at S43 is removed (S43: Yes), the CPU 15 proceeds to S41 to standby for the USB memory 30 to be mounted. Although the processing thereafter is substantially the same as in the illustrative aspect shown in FIG. 5, after displaying a message to urge the user to remove the USB memory 30 at S49, the CPU 15 sets the restart request flag to “on” (S51) without confirming that the USB memory 30 is removed (without executing S50), and then ends the automatic setting program.

According to the present illustrative aspect, since rewriting of settings information is not executed when the USB memory 30 is already mounted at startup, it is possible to prevent the occurrence of the problem of initiating a rewriting of settings information and a restart operation (from being repeated) with the USB memory 30 still in a mounted state.

Further, at the time of restart after executing a settings update, even when the USB memory 30 is mounted before startup is completed and update of settings is not performed immediately, it is possible to update the settings without restarting the printer 1 by removing and then remounting the USB memory 30. Thus, ease-of-use is enhanced.

According to the above described illustrative aspects, although a configuration was described in which, after rewriting the settings, a message is displayed that urges the user to remove the external memory and thereafter a message is displayed that urges the user to execute a restart operation, a configuration may also be adopted in which, for example, reading of a settings file of an external memory and then display of a message urging the user to remove the external memory are performed prior to performing an operation to rewrite the settings, and thereafter, when removal of the external memory is detected, rewriting of settings and a restart operation are executed.

Although according to the above described illustrative aspects a configuration was described in which restart was performed without fail after updating the settings, a configuration may also be adopted in which restart is not executed when only settings for which restart is not required are changed.

Although according to the above described illustrative aspects a description was made that took a USB memory as an example of an external memory, an external memory according to the present invention is not limited thereto. For example, the external memory may be a compact flash®, a smart media®, a memory stick™, or an external hard disc drive.

What is claimed is:

1. An image forming apparatus, comprising:
an integrated memory portion capable of storing settings information;
a memory connection portion communicably connected to an external memory capable of storing settings update information;
a detection portion capable of detecting a connected state and a disconnected state of the external memory with respect to the memory connection portion;
a settings updating portion capable of rewriting settings information that is stored in the integrated memory portion based on settings update information that is stored in the external memory; and
a control portion capable of executing restarting of the image forming apparatus after the settings updating portion executes rewriting of the settings information, based on a signal from the detection portion that the external memory is in the disconnected state.

2. An image forming apparatus, comprising:
an integrated memory portion configured to store settings information;
a memory connection portion detachably connected to an external memory configured to store settings update information;
a detection portion configured to detect a connected state and a disconnected state of the external memory with respect to the memory connection portion;
a settings updating portion configured to rewrite settings information that is stored in the integrated memory portion based on settings update information that is stored in the external memory;
a display portion;
a restart console configured to perform an operation for executing restart of the image forming apparatus; and
a control portion configured to execute rewriting of the settings information by the settings updating portion based on a signal from the detection portion that the external memory is in the disconnected state and displays on the display portion an instruction message instructing a user to execute restart after removing the external memory, and thereafter executes restart of the image forming apparatus based on an operation of the restart console.

3. The image forming apparatus according to claim 2, wherein the instruction message comprises:
a remove message that instructs a user to remove the external memory, and a restart message that is displayed after the detection portion detects that the external memory is removed and that instructs the user to execute a restart operation.

4. An image forming apparatus, comprising:
an integrated memory portion that stores settings information;
a memory connection portion to which an external memory that stores settings update information is detachably connected;
a detection portion that detects a mounting state of the external memory with respect to the memory connection portion;
a settings updating portion that rewrites settings information that is stored in the integrated memory portion based on settings update information that is stored in the external memory; and
a control portion that, when the detection portion detects that the external memory is mounted, executes restarting of the image forming apparatus after the settings updating portion executes rewriting of the settings information, and when the detection portion detects that the external memory is in a mounted state at a startup time, does not execute rewriting of the settings information by the settings updating portion or restart of the image forming apparatus.

5. The image forming apparatus according to claim 4, wherein, in a case where the detection portion detects that the external memory is in a mounted state at a startup time, when the detection portion detects that the external memory is removed once and thereafter remounted, the control portion executes rewriting of the settings information by the settings updating portion and restart of the image forming apparatus.

6. The image forming apparatus according to claim 1, further comprising:
an input portion that enables an input operation for executing a settings update;
wherein, when performing rewriting of the settings information, the control portion executes rewriting of the settings information when an input operation for executing a settings update is performed at the input portion, and cancels rewriting of the settings information when an input operation for not executing a settings update is performed at the input portion.

7. The image forming apparatus according to claim 2, further comprising:
an input portion that enables an input operation for executing a settings update;
wherein, when performing rewriting of the settings information, the control portion executes rewriting of the settings information when an input operation for executing a settings update is performed at the input portion, and cancels rewriting of the settings information when an input operation for not executing a settings update is performed at the input portion.

8. The image forming apparatus according to claim 4, further comprising:
an input portion that enables an input operation for selecting whether or not a settings update is to be executed;
wherein, when performing rewriting of the settings information, the control portion executes rewriting of the settings information in a case where an input operation to the effect that a settings update is to be executed is performed at the input portion, and cancels rewriting of the settings information in a case where an input operation to the effect that a settings update is not to be executed is performed at the input portion.

9. The image forming apparatus according to claim 1, further comprising:
a RAM; and
an allocating portion capable of executing area allocation processing with respect to the RAM based on the settings information at a time of startup of the image forming apparatus.

10. The image forming apparatus according to claim 2, further comprising:
a RAM; and
an allocating portion configured to execute area allocation processing with respect to the RAM based on the settings information at a time of startup of the image forming apparatus.

11. The image forming apparatus according to claim 4, further comprising:
a RAM; and
an allocating portion that, at a time of startup of the image forming apparatus, executes area allocation processing with respect to the RAM based on the settings information.

12. The image forming apparatus according to claim 1, further comprising:
a storage portion capable of storing the settings update information that is stored on the external memory;
wherein, after storage of the settings update info in the storage portion is completed, the settings updating portion executes rewriting of settings update information that is stored in the storage portion based on the settings information.

13. The image forming apparatus according to claim 2, further comprising:
a storage portion configured to store the settings update information that is stored on the external memory;
wherein, after storage of the settings update information in the storage portion is completed, the settings updating portion executes rewriting of settings update information that is stored in the storage portion based on the settings information.

14. The image forming apparatus according to claim 4, further comprising:
a storage portion that stores the settings update information that is stored on the external memory;
wherein, after storage to the storage portion of the settings update information that is stored on the external memory is completed, the settings updating portion executes rewriting of settings update information that is stored in the storage portion based on the settings information.

15. The image forming apparatus according to claim 1, wherein the memory connection portion is communicably connected to the external memory via a USB interface.

16. The image forming apparatus according to claim 1, wherein the external memory is at least one of a nonvolatile memory device and hard disc drive memory device.

17. The image forming apparatus according to claim 2, wherein the external memory is at least one of a nonvolatile memory device and hard disc drive memory device.

18. The image forming apparatus according to claim 4, wherein the external memory is at least one of a nonvolatile memory device and hard disc drive memory device.
